(19) United States
(12) Patent Application Publication
(10) Pub. No.: US 2004/0025993 A1
(43) Pub. Date: Feb. 12, 2004

(54) Protective pad attachment for portable computing devices

(76) Inventor: Paul Grady Russell, Campbell, CA (US)

Correspondence Address: HEWLETT-PACKARD COMPANY, Intellectual Property Administration, P.O. Box 272400, Fort Collins, CO, 80527-2400, US

(21) Appl. No.: 10/214,795

(22) Filed: Aug. 7, 2002

(51) Int. Cl. A47F 5/00; A47F 7/00; F16M 11/00

(52) U.S. Cl. 150/154; 150/158; 248/125.1

(57) ABSTRACT

An apparatus and method for providing a protective cover for use on a portable electronic device to substantially prevent harmful impacts thereto. The protective cover may include peripheral pad elements each having a mounting surface and an impact portion and a retention member for retaining the protective cover to the electronic device. The mounting surface for each peripheral pad element may include at least one shoulder extending substantially perpendicularly from the mounting surface so that each peripheral pad element can be positioned in a nested arrangement with at least one peripheral edge of the electronic device. In this manner, the impact portion for each peripheral pad elements provide an exposed, resilient cushion to substantially prevent harmful impact to the electronic device.

### THE FIELD OF THE INVENTION

The present invention relates generally to a device and method for protecting portable electronic devices from damage that occurs during regular use. More particularly, the present invention relates to a protective cover configured for attaching to a portable electronic device.

### BACKGROUND OF THE INVENTION

Consumers have used portable or laptop computers in an ever-increasing variety of environments and industries under numerous and differing operating conditions since the introduction of portable computing devices in the early 1990's. Computer manufacturers have sought to satisfy this consumer trend by producing more functional and portable computing devices. The computer industry often refers to such computing devices as “portable desktop” computers, capable of performing any task the home computer could, but in a portable format. In addition to increased functionality, computer manufactures have striven to reduce the size and weight of portable computer devices, thus making it easier for computer users to transport and operate their computer in a multitude of environments. Several industries including oil exploration, fire fighters, police departments and the military require rugged workplace applications for portable computing devices, thus regularly placing portable computing devices in some of the most extreme and demanding environments. Even the general public has now developed a high expectation of desirability for such portable computing devices to endure severe impacts and falls.

Recognizing a need to protect portable computing devices from the hazards inherent to portability and the environments in which these devices are being used, in the past, computer manufactures have offered increased protection for portable computing devices in the form of an additional carrying case. However, such cases have two major disadvantages. First, several of the carrying cases currently available represent a significant added expense to the consumer, and second, most carrying cases offering a reasonable amount of protection are bulky and cumbersome, thus reducing the overall portability of the computer. More importantly, many falls and impacts occur during use and are not subject to the protection of a carrying case.

Recognizing a need to further alleviate the aforementioned problems, computer manufacturers have recently begun manufacturing portable computing devices containing components designed for more rigorous applications. These “hardened components” include magnesium alloy cases or chassis and shock mounted hard drives. Although the addition of hardened components is effective these components add considerably to the cost, weight and/or size of any portable computing device. Likewise, it is often mechanically impossible or cost prohibitive to retrofit an existing portable computing device with hardened components, thus leaving millions of existing portable computing devices vulnerable to potential damage.

In view of the foregoing, a device that provides protection for a portable computing device is desirable. Additionally, such a device that does not add significantly to the weight, size or cost of the computing device is highly desirable. Finally, a protective device capable of protecting both new and existing portable computing devices is extremely desirable.

### SUMMARY OF THE INVENTION

The present invention encompasses a protective cover for use on a portable electronic device. The protective cover includes a plurality of resilient peripheral pad elements which are mounted to the periphery of the electronic device. Each peripheral pad element is designed with both a mounting surface and an impact portion. The pad elements are peripherally attached to the electronic device by one of several retention means.

In a more specific embodiment, the mounting surface of the peripheral pad elements provide at least one shoulder extending substantially perpendicularly from the mounting surface, wherein the mounting surface and the at least one shoulder are configured for receiving a peripheral edge of the electronic device in nested position. By positioning the peripheral pad elements about the periphery of the electronic device, the electronic device is substantially protected from potential impacts thereto.

The present invention may also include an intermediate pad element having a mounting surface and an impact portion. The intermediate pad is designed to be attached to a planar portion of the electronic device, which may include a central portion of the surface of the computing device clear of any openings used to access internal components thereof. The intermediate pad may be separate and discrete from each of the peripheral pad elements or the intermediate pad may be interconnected to each of the peripheral pad elements with extension portions therebetween. In this manner, the peripheral pad elements and intermediate pad, whether as separate, discrete elements or interconnected, provide a protective cover that cushions and absorbs potentially harmful impacts to the electronic device.

The present invention may also include a retention member disposed on the mounting surface and/or the at least one shoulder of each of the peripheral pad elements and the mounting surface of the intermediate pad. Such retention member may include at least one of an adhesive, double sided adhesive tape, and mechanical fasteners. Additionally, in the case of the peripheral pad elements being interconnected to the intermediate member, the retention member may include an interference fit between the at least one shoulder of each of the peripheral pad elements and the peripheral edge of the electronic device via an elastic force between the interconnected peripheral pad elements.

Other features and advantages of the present invention will become apparent to those of ordinary skill in the art through consideration of the ensuing description, the accompanying drawings, and the appended claims.

### BRIEF DESCRIPTION OF THE DRAWINGS

While the specification concludes with claims particularly pointing out and distinctly claiming that which is regarded as the present invention, the advantages of this invention may be ascertained from the following description of the invention when read in conjunction with the accompanying drawings, in which:

FIG. 1 illustrates a side perspective view of protective pads mounted to a portable electronic device, according to a first embodiment of the present invention;

FIG. 2 illustrates a side perspective view of the protective pad, according to the first embodiment of the present invention;

FIG. 3 illustrates a side perspective view of protective pads mounted to a portable electronic device, according to a second embodiment of the present invention;

FIG. 4 illustrates a side perspective view of the protective pad, according to the second embodiment of the present invention;

FIG. 5 illustrates a side perspective view of a protective pad mounted to a portable electronic device, according to a third embodiment of the present invention;

FIG. 6 illustrates a bottom plan view of the protective pad, according to the third embodiment of the present invention;

FIG. 7 illustrates a side perspective view of a protective pad mounted to a portable electronic device, according to a fourth embodiment of the present invention; and

FIG. 8 illustrates a bottom plan view of the protective pad, according to the fourth embodiment of the present invention.

### DETAILED DESCRIPTION OF THE INVENTION

Preferred embodiments of the present invention will be hereinafter described with reference to the accompanying drawings. It should be understood that the illustrations are not meant to be actual views of any particular apparatus and/or method, but are merely idealized representations which are employed to more clearly and fully depict the present invention than would otherwise be possible. Additionally, elements and features common between the figures retain the same numerical designation.

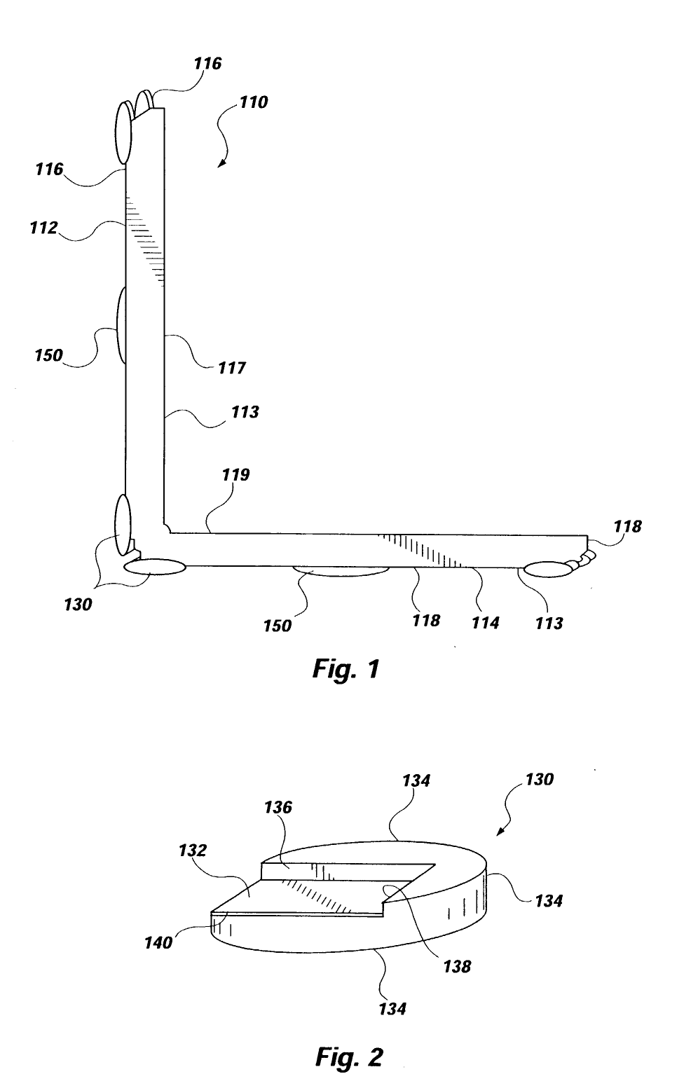

Referring first to FIG. 1, a perspective view of protective pads mounted to a portable electronic device 110 is illustrated. Such a portable electronic device 110 may include, but is not limited to, a laptop computer, a palm digital assistant (PDA), a cell phone, or some other type of data storing and/or communication device.

The portable electronic device 110 may include a first portion 111 and a second portion 113, wherein the first portion 111 includes a top surface 112 and inside surface 117 and the second portion 113 includes a bottom surface 114 and inside surface 119. The portable electronic device 110 may also include a top peripheral surface 116 and a bottom peripheral surface 118, each defined between the top surface 112 and inside surface 117 and between the bottom surface 114 and inside surface 119, respectively. Each of the peripheral surfaces 116 and 118 extend to their respective top and bottom surfaces 112 and 114 with peripheral edges and corner portions therebetween. As such, the first portion 111 and second portion 113 of the portable electronic device 110 typically is configured to swing to an open and closed position via a hinge interconnecting the first and second portions 111 and 113.

The protective pads may include peripheral pads 130 and one or more intermediate pads 150. The peripheral pads 130 may be positioned along peripheral edges and, preferably, along peripheral corners between the top surface 112 and top peripheral surface 116 and/or between the bottom surface 114 and bottom peripheral surface 118 of the portable electronic device 110. The intermediate pads 150 may be positioned proximate an intermediate or central location on the top surface 112 and bottom surface 114 of the portable electronic device 110.

The protective pads, i.e., peripheral pad, intermediate pad, are resilient and designed to absorb and reduce the force of an impact and substantially rebound to their original size and shape. The protective pads may be formed of foam, polymer, rubber and/or any other suitable material known in the art.

Referring now to FIG. 2, there is illustrated a side perspective view of the peripheral pad 130. Such a peripheral pad 130 includes a mounting surface 132 with first and second shoulders 136 and 138 extending substantially perpendicularly therefrom and an impact portion 134. The mounting surface 132 along with the first and second shoulders 136 and 138 are sized and configured to mount to a corner portion of the portable electronic device 110 (FIG. 1). For example, the peripheral pad 130 is positioned with the portable electronic device 110 so that the mounting surface 132 abuts with a corner portion of the top surface 112 while the first and second shoulders 136 and 138 abut with corner portions of the top peripheral surface 116 of the portable electronic device 110. In this manner, the first and second shoulders 136 and 138 in combination with the mounting surface 132 provide a stabilized, nesting arrangement between the peripheral pad 130 and a corner portion of the portable electronic device 110. In addition, the first and second shoulders 136 and 138 of the peripheral pad 130 are sized and configured such that they provide lateral resistance to lateral impact to the peripheral pad 130.

The impact portion 134 of the peripheral pad 130 may include any portion or surface of the peripheral pad 130 exposed when the peripheral pad 130 is in the mounted position. The impact portion 134 of the peripheral pad 130 is configured to reduce the consequences of bumping and dropping the portable electronic device 110. As such, the impact portion 134 of the peripheral pad 130 is configured to include convex surfaces to provide cushioning and absorb harmful impacts to the portable electronic device 110. Additionally, the impact portion 134 of the peripheral pad 130 extends outwardly beyond the edges and corners of the portable electronic device 110 so that the impact portion 134 substantially receives and absorbs any potential harmful impacts from most any direction, protecting the portable electronic device 110. Such impact portion 134 may extend at least a quarter inch beyond the edge of the portable electronic device 110 and, preferably, at least a half-inch.

Further, the impact portion 134 of the peripheral pad 130 may include a thermoplastic or fabric-type cover that is bonded to the peripheral pad 130 by an adhesive, thereby, providing additional protection and cushioning to the portable electronic device 110. Such covers may be of any color or design for visually aesthetic enhancement and personalization of the portable electronic device 110.

In addition, the mounting surface 132 of the peripheral pad 130 may include a retention member 140, such as an adhesive, formed thereon. Retention member 140 may also be formed over the first and second shoulders 136 and 138. Retention member 140 may include a cover formed of a paper and/or polyimide, which may be readily removable from an adhesive portion of the retention member 140. With this arrangement, the cover may be removed from the retention member 140 so that the adhesive portion is exposed, wherein the peripheral pad 130 may be attached and retained to a desired portion of the portable electronic device 110. Retention member 140 may also be provided, as known in the art, by any chemical-type adhesive, double stick tape, snaps or other mechanical fasteners and most any other suitable means for retaining the protective pads to the portable electronic device 110.

Referring again to FIG. 1, similar to the peripheral pad 130, the intermediate pad 150 includes an impact portion 152 and a mounting surface (not shown). Such mounting surface may include a retention member for attaching and retaining the intermediate pad 150 to the portable electronic device 110 via an adhesive. The impact portion 152 of the intermediate pad 150 may also include any exposed surface thereof when the intermediate pad 150 is mounted to the portable electronic device 110. The intermediate pad 150 is sized and configured to attach to a planar surface such as a substantially central portion of the top surface 112 or bottom surface 114 of the portable electronic device 110.

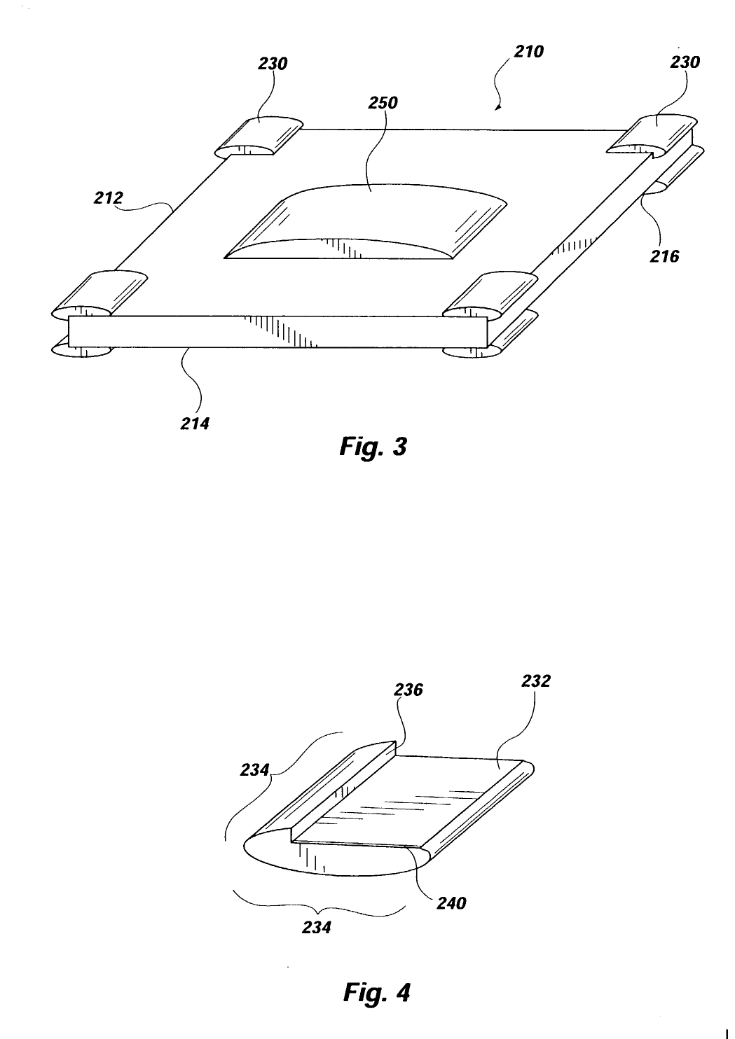

Turning to FIGS. 3 and 4, a second embodiment of the protective pad mounted to a portable electronic device 210 and the protective pad alone are respectively illustrated. In the second embodiment, the protective pad may include a peripheral pad 230 and/or an intermediate pad 250. The peripheral pad 230 includes a mounting surface 232, a retention member 240 and an impact portion 234, similar to the first embodiment. However, in the second embodiment, there is only a single shoulder 236 that extends substantially perpendicular from the mounting surface 232. The single shoulder 236 is sized and configured to mount to a periphery 216 of the electronic device 210 while the mounting surface 232 is sized and configured for mounting to either the top surface 212 or bottom surface 214 of the electronic device 210.

With the peripheral pad 230 having the single shoulder 236, the peripheral pad 230 may be positioned along any portion along an edge between the periphery 216 and either the top surface 212 or bottom surface 214 of the portable electronic device 210. Further, such peripheral pad 230 may be positioned along one edge to extend over an adjacent second edge so that the over extending portion of the peripheral pad 230 may absorb lateral blows to such peripheral pad 230. Such impact portion 134 may extend at least a quarter inch beyond the one edge and/or the adjacent second edge of the portable electronic device 110 and, preferably, at least a half-inch. Additionally, peripheral pads 230 may be positioned along opposing edges as well as the adjacent edges to such opposing edges of the electronic device 210.

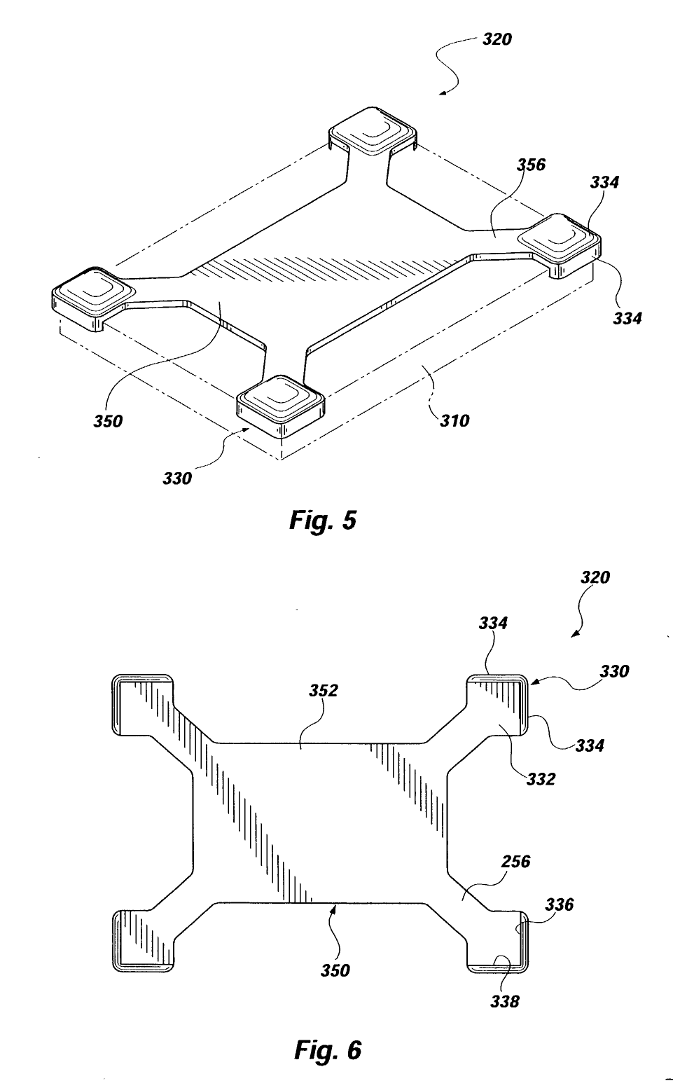

Referring to FIGS. 5 and 6, a third embodiment of a protective pad 320 is illustrated. As in the previous embodiments, protective pad 320 is mountable to a portable electronic device 310. However, in the third embodiment, protective pad 320 includes extension portions 356 extending between peripheral pads 330 and intermediate pad 350 in an “x-type” configuration, wherein the protective pad 320 is sized and configured to mount over a top surface 312 or a bottom surface 314 and their respective corner portions of the portable electronic device 310. The extension portions 356 may be formed integrally or interconnected with the peripheral pads 330 and/or intermediate pad 350.

In the third embodiment, each of the peripheral pads 330 may include a mounting surface 332 and an impact portion 334, similar to previous embodiments. Further, each peripheral pad 330 includes first and second shoulders 336 and 338 extending substantially perpendicularly from the mounting surface 332, wherein the mounting surface 332 and each of the first and second shoulders 336 and 338 are configured to abut with and provide a stabilized, nesting arrangement with a corner portion of the portable electronic device 310. Additionally, the intermediate pad 350 and extension portions 356 are configured to be disposed over the top surface 312 or bottom surface 314 of the portable electronic device 310.

The mounting surface 332 of the peripheral pads 330 may include a retention member, such as an adhesive, for attaching and retaining the peripheral pads 330 to the electronic device 310. Further, the retention member may also be formed on the mounting surface 352 of the intermediate member as well as the underside surface of the extension portions 356 to provide additional retaining strength of the protective pad 320 as a whole.

In the third embodiment, the retention member may also include an interference fit via an elastic force between each of the peripheral pads 330 positioned over each of the corner portions of the portable electronic device. Thus, the protective pad 320 is sized and configured so as to provide a tight, snub interference fit so that the intermediate pad and/or the extension portions elastically stretch to provide an elastic force when the peripheral pads are positioned in the nested position at the corner portions of the electronic device 310. In other words, the interconnected peripheral pads 330 are respectively held in place to the corner portions via an interference fit and elastic force of the respective first and second shoulders 336 and 338 of each peripheral pad 330 elastically abutting the corner portions of the electronic device 310. With this arrangement, the protective pad 320 provides a retention member with respect to the electronic device 310 that readily allows the protective pad 320 to be mounted, removed and/or replaced as desired while still providing the necessary protection against harmful impacts to such portable electronic device 310.

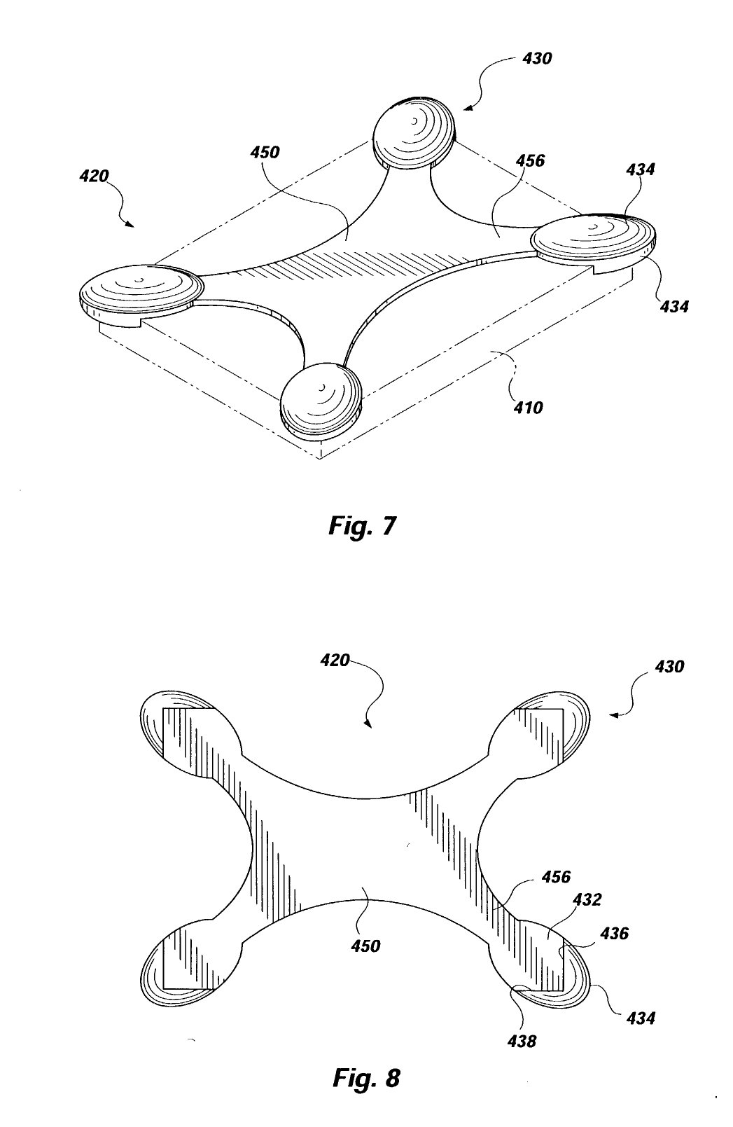

FIGS. 7 and 8 illustrate a variant of the third embodiment of the protective pad 420 of the present invention. In particular, the protective pad includes peripheral pads 430 and an intermediate pad 450 with extension portions 456 therebetween, wherein an impact portion 434 of the peripheral pads 430 include a convex surface. Further, the extensions 456 extending from the intermediate pad 450 extend with an uninterrupted, continuous curve. As in the third embodiment, each peripheral pad 430 includes a mounting surface 432 with first and second shoulders 436 and 438 for providing a stabilized, nesting position or nesting arrangement with the corner portions of the portable electronic device 410. In this variant, the retention means may be provided via an adhesive or an interference fit, as in the third embodiment.

While the present invention has been disclosed in terms of exemplary embodiments and variations thereof, those of ordinary skill in the art will recognize and appreciate that the invention is not so limited. Those of ordinary skill in the art will recognize and appreciated that many additions, deletions and modifications to the disclosed embodiment and its variations may be implemented without departing from the scope of the invention, which is limited only by the appended claims and their legal equivalents.

What is claimed is:

1. A protective cover for use on a portable electronic device having a top surface and a bottom surface with at least one peripheral edge, said cover comprising:
peripheral pad elements each having a mounting surface and an impact portion, said mounting surface configured for attachment to the at least one peripheral edge of the electronic device, said impact portion operable as an exposed, resilient cushion; and
a retention member configured to attach and retain said peripheral pad elements to the electronic device; and
wherein said mounting surface of said each of said peripheral pad elements extends to and includes at least one shoulder extending substantially perpendicularly therefrom, said at least one shoulder and said mounting surface configured to receive the at least one peripheral edge of the electronic device in a nested position and to stabilize said each of said peripheral pad elements against an impact thereto.

2. The protective cover of claim 1, wherein said peripheral pad elements comprises a width to extend at least partially beyond the at least one peripheral edge of the electronic device to provide lateral cushioning against said impact thereto.

3. The protective cover of claim 1, further comprising an intermediate pad having a mounting surface and an impact portion, said mounting surface configured to be disposed over at least one of the top surface and the bottom surface of the electronic device.

4. The protective cover of claim 1, wherein said impact portion of said each of said peripheral pad elements includes a convex contact surface for enhanced cushioning of the electronic device against said impact directed toward said convex contact surface.

5. The protective cover of claim 1, wherein said peripheral pad elements include at least one peripheral pad element having a first shoulder and a second shoulder extending substantially perpendicularly from said mounting surface and sized and configured to be disposed at a corner portion of the portable electronic device.

6. The protective cover of claim 1, wherein said peripheral pad elements are separate and discrete from each other.

7. The protective cover of claim 3, wherein said at least one intermediate pad is interconnected with said peripheral pad elements with extension portions therebetween as part of an integrated protective cushion.

8. The protective cover of claim 1, wherein said retention member is formed over at least said mounting surface of said peripheral pad elements.

9. The protective cover of claim 1, wherein said retention member comprises at least one of an adhesive, double-sided adhesive tape, and mechanical fasteners.

10. The protective cover of claim 7, wherein said retention member is configured to provide an interference fit between said at least one shoulder of said each of said peripheral pad elements and the at least one peripheral edge of the electronic device via an elastic force between said interconnected peripheral pad elements.

11. The protective cover of claim 7, wherein said at least one intermediate pad interconnected to said peripheral pad elements forms an x-type configuration.

12. The protective cover of claim 1, wherein said peripheral pad elements comprises at least one of a foam material and a polymeric material.

13. A protective cover for use on a portable electronic device having a top surface and a bottom surface with at least one peripheral edge, said cover comprising:
peripheral pad elements each having a mounting surface and an impact portion, said mounting surface configured for attachment to the at least one peripheral edge of the electronic device, said impact portion operable as an exposed, resilient cushion;
at least one intermediate pad having a mounting surface and an impact portion operable as an exposed, resilient cushion, said mounting surface configured to be disposed on at least one of the top surface and the bottom surface of the electronic device, said at least one intermediate pad interconnected to said peripheral pad elements with extension portions therebetween; and
wherein said mounting surface of said each of said peripheral pad elements extends to and includes at least one shoulder extending substantially perpendicularly from said mounting surface, said at least one shoulder and said mounting surface configured to receive the at least one peripheral edge of the electronic device in a nested position so that said at least one shoulder extending from said mounting surface on each of said peripheral pad elements is configured to be retained to the electronic device via an interference fit and elastic force between said interconnected peripheral pad elements.

14. The protective cover of claim 13, wherein said peripheral pad elements each comprise a width to extend at least partially beyond the at least one peripheral edge of the electronic device to provide lateral cushioning against an impact thereto.

15. The protective cover of claim 13, wherein said impact portion of said each of said peripheral pad elements includes a convex contact surface for enhanced cushioning of the electronic device against said impact directed toward said convex contact surface.

16. The protective cover of claim 13, wherein said each of said peripheral pad elements include at least one peripheral pad element having a first shoulder and a second shoulder extending substantially perpendicularly from said mounting surface and sized and configured to be disposed at a corner portion of the portable electronic device.

17. The protective cover of claim 15, further comprising a retention member comprising at least one of an adhesive, double-sided adhesive tape, and mechanical fasteners disposed over at least said mounting surface of said peripheral pad elements.

18. A method of making a protective pad for substantially protecting a portable electronic device having a top surface and a bottom surface with at least one peripheral edge from impacts to the protective pad, the method comprising:
forming peripheral pad elements each having a mounting surface configured to attach to the at least one peripheral edge and an impact portion operable as an exposed, resilient cushion;
configuring said peripheral pad elements with a retention member for attaching and retaining said peripheral pad elements to the electronic device; and
configuring said each of said peripheral pad elements with at least one shoulder extending substantially perpendicularly from said mounting surface, and configuring said at least one shoulder and said mounting surface to receive the at least one peripheral edge of the electronic device in a nested position and to stabilize said each of said peripheral pad elements against an impact thereto.

19. The method of claim 18, further comprising forming an intermediate pad having a mounting surface configured to be disposed on at least one of the top surface and the bottom surface of the electronic device and an impact portion operable as an exposed, resilient cushion.

20. The method of claim 19, wherein:
said forming said intermediate pad comprises configuring said intermediate pad to be interconnected to said peripheral pad elements with extension portions therebetween; and
said configuring said peripheral pad elements with said retention member comprises configuring said at least one shoulder extending from said mounting surface on each of said peripheral pad elements to be retained to the electronic device via an interference fit and elastic force between said interconnected peripheral pad elements.
